(19) United States
(12) Patent Application Publication
(10) Pub. No.: US 2010/0080889 A1
(43) Pub. Date: Apr. 1, 2010

(54) METHOD AND EQUIPMENT FOR THE CONTINUOUS DEPOSITION OF A COATING ON A STRIP TYPE SUBSTRATE

(75) Inventors: Jean-Jacques Hardy, Irigny (FR); Sebastien Martin, Neuilly Sur Seine (FR); Fabrice Duvivier, Reyrieux (FR)

Correspondence Address: LERNER GREENBERG STEMER LLP, P O BOX 2480, HOLLYWOOD, FL, 33022-2480, US

(73) Assignee: SIEMENS VAI METALS TECHNOLOGIES SAS, Saint Chamond (FR)

(21) Appl. No.: 12/529,941

(22) PCT Filed: Dec. 20, 2007
(86) PCT No.: PCT/FR2007/052578

§ 371 Date: Sep. 4, 2009

(30) Foreign Application Priority Data
Mar. 7, 2007 (FR) 0701660

(51) Int. Cl. B05D 1/00; B05C 11/00

(52) U.S. Cl. 427/9; 118/665

(57) ABSTRACT

In the continuous deposition of a coating on strip-type substrate, a thickness of the coating depends on the condition of various actuators. A first preliminary phase of the process includes developing a pre-setting model, a second preliminary phase includes developing an adjustment model, an intermediate pre-setting step during which the actuators are set statically, a step of measuring the thickness of the coating, and an adjustment step during which the actuators are dynamically controlled by a predictive control based on the adjustment model in order to reduce any potential difference between the coating measured thickness and a target value of the thickness.

The invention relates in general terms to industrial techniques of surface treatment, specifically as applied to the longitudinal and transverse control of the thickness of a metal coating deposited in the hot state on a steel strip in a continuous galvanizing installation.

According to a first aspect, the invention relates more precisely to a method for the continuous deposition of a coating on a strip-type substrate of defined width with convergence toward at least one target value of the thickness of this coating on the substrate surface, this method comprising a deposition operation during which the substrate is conveyed along a longitudinal feed direction perpendicular to its width in an installation comprising a set of actuators controlled by respective control signals each comprising at least one component, each actuator being suitable for acting on the thickness of the coating along the width of the substrate as a function of the control signal that it receives.

The invention will be considered chiefly in its preferred application to galvanizing, in which the substrate is formed of a steel strip and the coating of a layer of zinc or an alloy of zinc, it being understood, however, that the invention is applicable to other industrial methods for continuous deposition of a coating on a substrate.

In all the fields where steel strips treated by continuous galvanizing are used, and in particular in the automotive and domestic appliance fields, it is wise to control the thickness of zinc or zinc alloy deposited as precisely as possible, the benefit of this control being both economic and technical.

On the economic level, users have activated research programs in order to define the thicknesses strictly necessary as a function of their specifications with the dual aim of reducing the quantity and therefore the cost of the coating and, correspondingly, limiting the share claimed by the cost of this coating in the overall price of the finished product, in order to minimize the impact of variations in the market price of zinc.

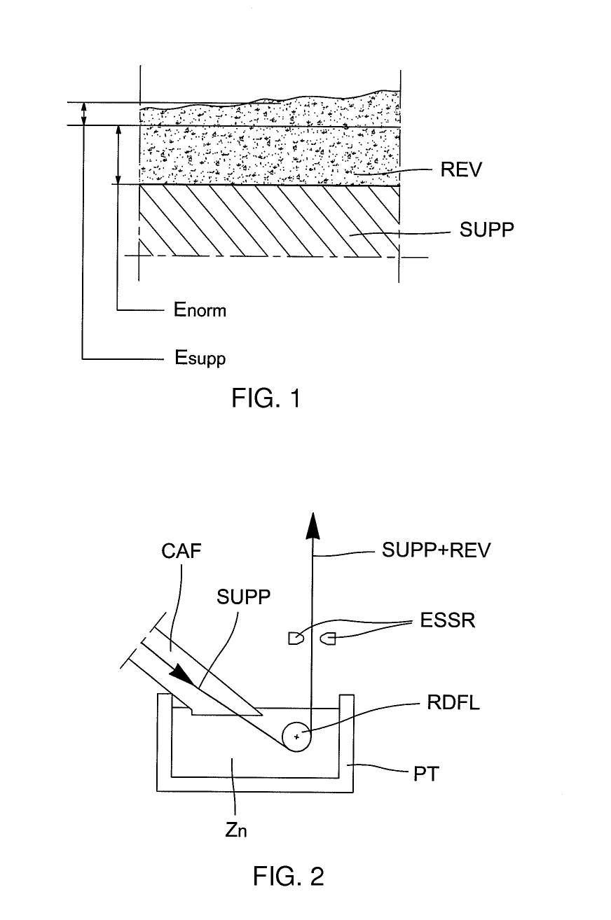

As shown in schematic form in FIG. 1, the usually required thickness Enorm of galvanized coating REV on the steel substrate SUPP, which is of the order of 10 microns for automotive applications and 25 microns for applications in construction, is generally increased by an undesirable excess thickness Esupp that represents 20% to 50% of the usual thickness Enorm.

On the technical level, the thickness of the coating REV chiefly exerts an effect on welding, specifically resistance welding. Large thicknesses necessitate large welding currents which adversely affect the service life of the electrodes. On the other hand, variations in thickness from one weld to another can give rise to defects or necessitate constant adjustments of the welding parameters.

Given this fact, efforts have been made going back a long time now to optimize the thickness of the coating while still ensuring the greatest possible homogeneity of this thickness. In particular, devices called “drying machines” have been developed to this end, allowing the thickness of the coating REV to be reduced prior to it solidifying, specifically by magnetic effect or by the blowing of air, drying machines of the latter type being the most widespread.

FIG. 2 shows the typical arrangement of a blown-air drying process on a continuous galvanizing line. The strip-type substrate SUPP, routed through an approach channel CAF of the furnace, plunges into a bath of zinc Zn or zinc alloy contained in a vat or “pot” PT, is deflected on a bottom deflecting roll RDFL, and passes with its coating REV in front of drying banks ESSR, which return to the pot PT the excess of zinc or alloy that is still in liquid form.

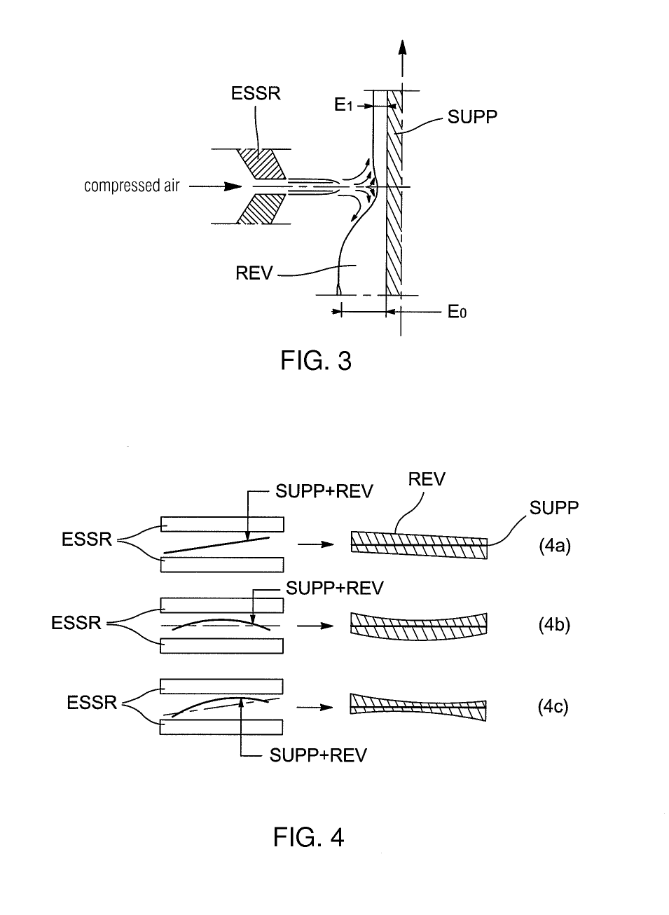

Thus, as shown in schematic form in FIG. 3, the thickness E0 that the coating layer REV displays at the exit from the liquid bath can be reduced, due to the compressed air blown by the drying machine ESSR, to a smaller value E1.

The principles of operation of the drying were established very early. For example, the patent JP 5-117832 identifies the main operating variables of this technique, namely (FIG. 12a of FIG. 12) the speed of the air jet, which depends on the pressure of the compressed air supplied to the drying machine ESSR and on the gap “e” between the lips ESSR1 and ESSR2 of this drying machine, the distance “d” between the lips of the drying machine and the strip-type substrate SUPP to be coated, and also the feed speed of the substrate SUPP. In fact (FIG. 12b of FIG. 12), the effect of a blown-air drying machine is a function of the pressure P of the air at the outlet of the lips ESSR1 and ESSR2 and the distance “d”, this effect remaining largely constant for values of the distance “d” that are at most equal to a limit “d0” and decreasing in a largely linear manner for distances with higher values.

Moreover, experience has allowed the operational variables and also the operating disturbances encountered to be identified more exhaustively.

These operational variables are typically the required thickness of coating on each of the faces of the strip, the format of the strip—that is to say in fact its width and its thickness for a continuous deposition on a strip that does not have a predefined length, the feed speed of the strip, and the tension of the strip in the coating zone.

The operating disturbances are essentially linked to the behavior of the strip in the drying zone and include poor centering of the strip in the space enclosed between the two drying machines, inclination of the strip with respect to the drying machines, and transverse camber of the strip, still referred to as “transverse bow” or “crossbow” by a person skilled in the art. FIG. 4, which is made up of FIGS. 4a to 4c, shows the effect of these defects on the thickness of the coating REV at the outlet of the drying machines ESSR. Thus, inclination of the strip with respect to the drying machines ESSR leads, in the transverse section of the strip, to a thickness gradient of the coating REV that is symmetrical with respect to the center of that section (FIG. 4a); the presence of a transverse curve or “transverse bow” leads to an asymmetric distribution of the coating REV on the two faces of the strip (FIG. 4b), and the presence of a transverse bow on an inclined strip leads to the accumulation of these defects (FIG. 4c).

It is worthwhile noting, however, that the presence of a transverse curve or transverse bow with a controlled value is nevertheless desirable to stiffen the ascending limb of the strip SUPP+REV that passes between the drying machines ESSR, such that the phenomenon illustrated in FIG. 4b cannot be eliminated entirely.

Other disturbances can likewise occur, such as localized undulations of the strip due to defects of the type “long edges” or “long center”, which generate local variations in thickness and which are additionally sources of vibration of the strip during its passage over the rolls.

There are also other sources of vibration of the strip, such as the progressive deterioration of the bearings of the immersed rolls and the rolls themselves, or the cooling air-blowing on the portion of strip located downstream of the drying machines.

In order to be able to react with respect to the changes in the operational variables and with respect to the operating disturbances, numerous constructional devices have been produced with a view to endowing the system with the necessary flexibility.

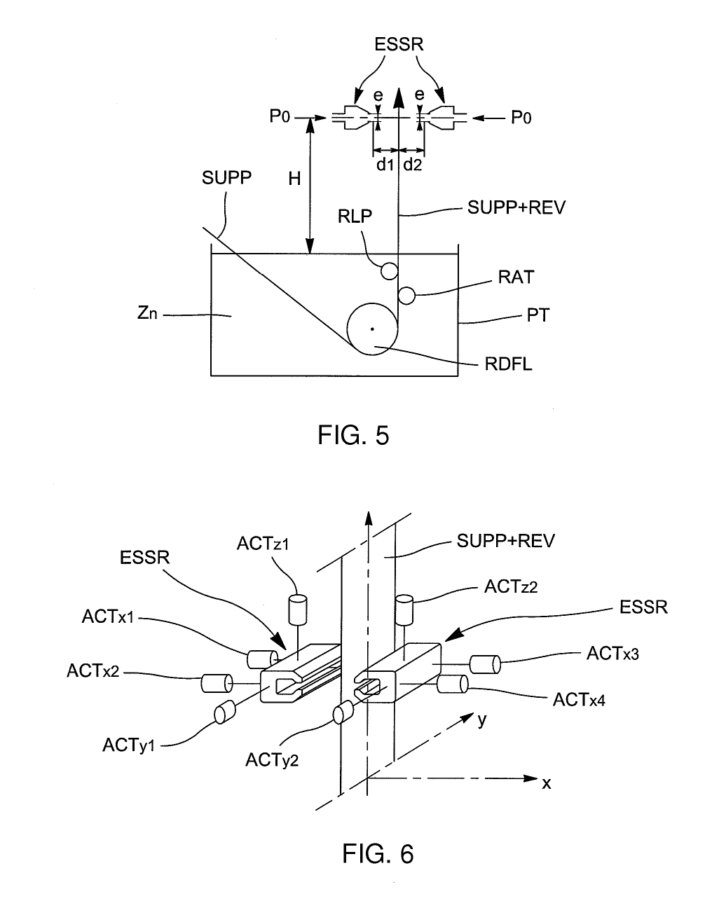

FIG. 5 illustrates the setting possibilities for the drying system itself. In practise, a system of this kind is equipped with actuators (which will be referred to generically as ACT) that allow the setting of the distance (d1 or d2) between the lips of each drying machine and the strip SUPP+REV, the gap (e) between the lips of the drying machines, the height (H) of the drying machines with respect to the bath of zinc, and the supply pressure P0 of gas to the drying machines.

These settings on their own allow control of the homogeneity of the thickness of the coating REV in the direction of feed of the strip-type substrate SUPP, and therefore in its longitudinal direction.

Control of the homogeneity of the thickness of the coating REV in the transverse direction of the strip SUPP, that is to say in the direction of its width, calls for several means.

First of all, this homogeneity can be controlled by a plurality of actuators performing the positional setting of the drying machines ESSR. FIG. 6 shows that the combination of the individual actions carried out by four actuators (ACTx1 to ACTx4) allows not only the axis of the strip to be centered between the drying machines ESSR but also variations in transverse inclination of the strip to be corrected. The actuators ACTy1, ACTy2, and ACTz1, ACTz2, which act respectively along the axes (y) and (z), allow the transverse position of the strip SUPP+REV between the drying machines ESSR to be adjusted respectively, and the height of these drying machines with respect to the bath of zinc to be set.

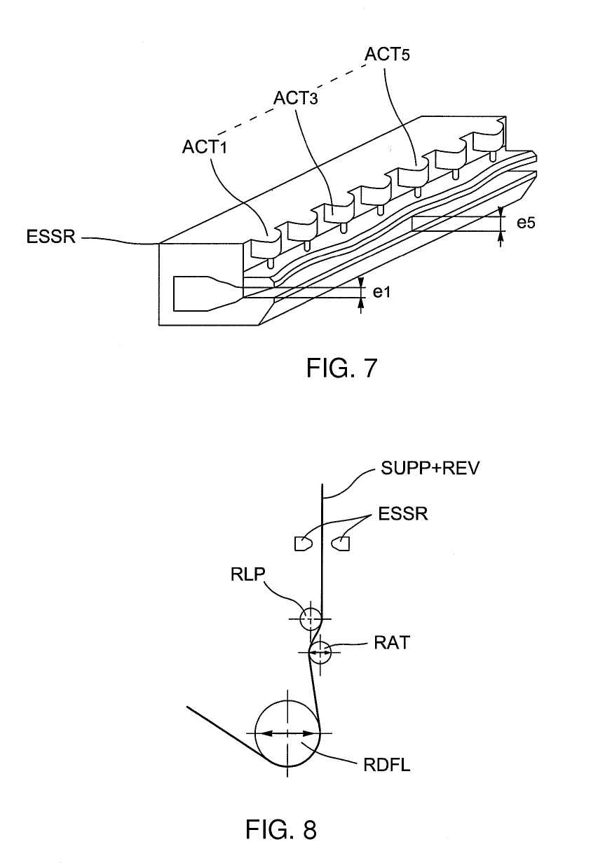

The homogeneity of the thickness of the coating REV in the transverse direction of the strip SUPP is likewise capable of being controlled by the deformation of the lips of the drying machines, as disclosed for example by the patent EP 0 566 497, which describes a device allowing the distance between the two lips of each of the drying machines to be adjusted in order to vary the thickness of the sheet of air. Multiple actuators such as ACT1, ACT3, ACT5 thus allow this thickness to be varied from one end of each drying machine ESSR to the other as shown in schematic form in FIG. 7, which represents several thicknesses of air sheet such as e1 and e5.

The homogeneity of the thickness of the coating REV in the transverse direction of the strip SUPP can further be controlled by the position of an “anti-crossbow” roll RAT, also referred to as an “anti-camber” roll, a roll of this type being arranged between the bottom deflecting roll RDFL and a pass line roll RLP. In fact, although the transverse camber or “transverse bow” of the strip-type substrate SUPP is corrected as far as possible by tensioning of this substrate in the furnace located upstream of the coating bath, there is still a more or less marked residual flatness defect in the galvanizing bath. As shown in FIG. 8, the residual camber just below the drying machines ESSR can be corrected at least elastically by horizontal movement of the “anti-crossbow” roll and/or the bottom deflecting roll RDFL with respect to the pass line roll RLP. This known method has been described in several patents and specifically in the patent JP 8-260122. With regard to the correction of camber, however, experience has shown, as indicated above, that vibrations and the effect of certain undulations could be limited by preserving a controlled camber in the strip that endows it with a certain longitudinal stiffness.

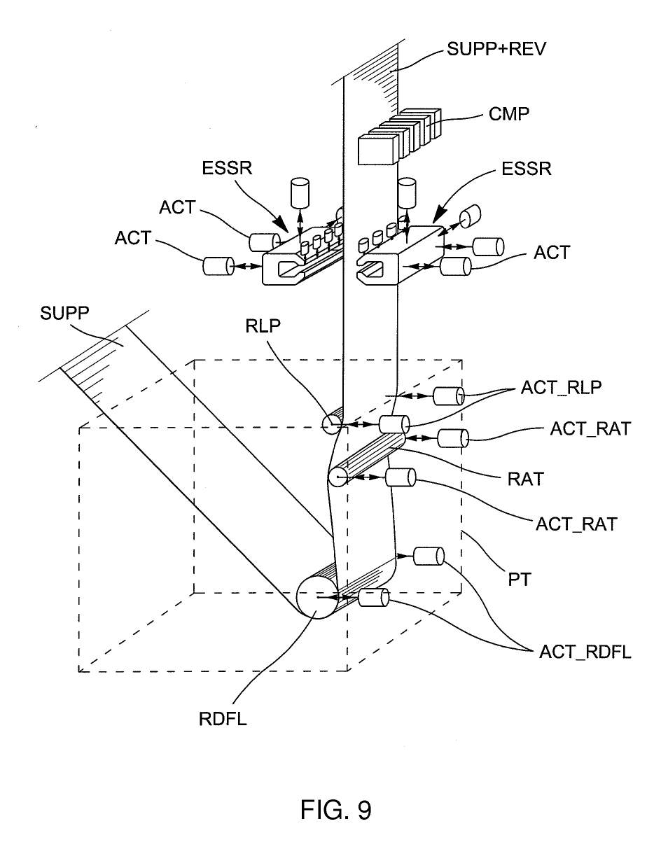

The homogeneity of the thickness of the coating REV in the transverse direction of the strip SUPP is likewise capable of being controlled by a magnetic or electromagnetic profile corrector CMP (FIG. 9). A system of this type, based on the use of a plurality of electromagnets, is described for example in the patent JP 9-108736.

Other settings can furthermore be useful, such as the setting of the angle of incidence of the jet of the drying machines ESSR with respect to the strip SUPP+REV, in particular to limit the risks of spattering of liquid zinc or “splashing”.

FIG. 9 shows the multiple potential actions available to control the homogeneity of the thickness of the coating. The means illustrated, found successively starting at the bottom of the zinc bath are:
horizontal movement by the actuators ACT_RDFL of the bottom deflecting roll RDFL and/or horizontal movement by the actuators ACT_RAT of the “anti-crossbow” roll to correct the camber of the strip SUPP+REV;
horizontal movement by the actuators ACT_RLP of the pass line roll RLP, which is sometimes necessary in certain cases to ensure the centering of the strip SUPP+REV between the heating inductors placed downstream of the drying machines ESSR;
the set of movements performed by the actuators of the drying machines ESSR already described with reference to FIG. 6;
transverse setting of the thickness of the air jet described with reference to FIG. 7; and
the actions of the split magnetic camber correctors CMP.

It should be pointed out that it is possible to classify these actuators in two families, that is to say the family of actuators with global effect that act on each complete drying machine by moving it parallel to itself or pivoting it, and the family of actuators with local effects that act separately on one part of the length of the drying machines, which include the actuators for transverse setting of the air jet and the split magnetic camber correctors.

All these actuators, whether they have a global effect or a local effect, can be controlled statically, that is to say set in advance of the deposition operation as a function of predefined operational variables corresponding to that operation, or dynamically, that is to say adjusted during their functioning.

Dynamic control is only meaningful if the movements of the actuators respond to a need highlighted by in-process measurements during the feeding of the strip.

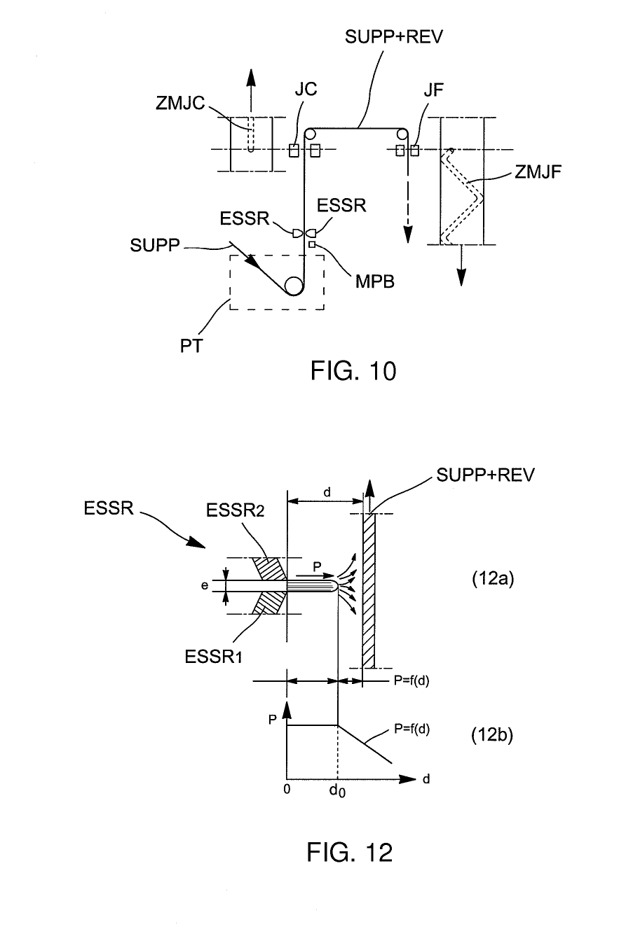

In the current state of the art, these measurements are essentially obtained by three types of instruments, which are illustrated in FIG. 10, that is to say:
a device MPB for measuring the profile of the strip arranged, for example, upstream of the drying machines ESSR, a device of this type being, for example, described in the patent JP 9-078215 and using laser lights;
a gauge JC for the thickness of coating, referred to as “hot”, installed downstream of the drying machines ESSR before the strip SUPP+REV is deflected horizontally; this gauge employs X rays that effect point measurement of the thickness of the coating REV; in general, the measuring zone ZMJC is located at the center of the strip and extends over the whole length of same as it is being fed; and
a gauge JF for the thickness of coating, referred to as “cold”, installed further downstream of the drying machines ESSR after the strip SUPP+REV has been deflected vertically again; this gauge likewise employs an X-ray source moving transversely to the strip; the measuring zone ZMJF describes a zigzag path over the whole length of the strip as it is being fed.

In this context, it is a known approach, specifically from the patent JP 9-087821, to perform guidance of the actuators by means of a system of control using both the presetting values entered by the operator prior to the deposition operation for the coating REV, and the in-process measurements obtained during that operation.

These known control systems are based on programs placing the measurements ‘online’ in the form of polynomial equations that are used to give the appropriate instructions to the various actuators.

But the use of these polynomial equations presents the twin disadvantages of leading to approximations rendering the instructions sent to the actuators with global effect imprecise and, above all, of being very difficult to apply to the actuators exerting local effects, which accumulate the actions of a plurality of elementary actuators capable of being guided separately.

The object of the invention is to rectify these disadvantages by proposing a method for the continuous deposition of a coating such as a layer of zinc on a strip-type substrate such as a strip of steel, which, to allow effective adjustment of the thickness of coating, is capable of precisely guiding multiple dynamic actuators, and which is easily applicable to complex actuators such as the transverse setting of the thickness of the jet of air or the split magnetic profile correctors.

To this end, the inventive method, conforming moreover to the generic definition given by the preamble above, is essentially characterized in that it comprises at least:
a first preliminary modeling phase, employed upstream of the deposition operation and comprising the development of a pre-setting model including, for each point in a set of points distributed along the width of the substrate and for each actuator, a quantitative relation linking the thickness of the coating at that point to the value of at least one component of the control signal supplied to that actuator;
a second preliminary modeling phase, employed upstream of the deposition operation and comprising the development of an adjustment model including, for each point in the set of points and for each actuator, a quantitative relation linking a variation of the thickness of the coating at that point to a variation in the value of at least one component of the control signal supplied to that actuator;
an intermediate pre-setting step, employed upstream or at the start of the deposition operation and comprising the operations consisting in sending control signals to the actuators depending on the pre-setting model and the target value for the thickness of the coating at each point in the set of points;
a measuring step, employed during the deposition operation and comprising the operations consisting in processing a measurement of the thickness of the coating at each point in the set of points; and
an adjustment step, employed during the deposition operation, following the pre-setting step, and comprising the operations consisting in sending respective control signals to the actuators, which signals have been processed by predictive control on the basis of the adjustment model and a cost function taking account of any potential difference between the target value and the thickness measurement at each point in the set of points.

Thus, although the specific techniques of predictive control are in themselves known, for example from the work “La commande prédictive” ['Predictive Control'] written by Jacques Richalet, Guy Lavielle, and Joëlle Mallet, published in 2004 by Editions Eyrolles, the invention proposes applying its principle to the dynamic control of actuators employed to control the thickness of the coating deposited on the substrate, while preserving the principle of static control of these actuators for their presetting.

Preferably, the adjustment model is a linear model, and the cost function is a quadratic function.

To the extent that it is desirable not to exclude from the employment of the inventive method the possibility for human operators to intervene directly on the sensors, and where an intervention of this type leads a priori to disturbing the adjustment model, it can be appropriate to provide that the inventive method additionally comprises an operation consisting in producing, at least at the level of each actuator in a group of actuators, at least one status signal that is representative of the status of that actuator, an operation consisting in acting on at least one actuator in the group through means complementing the sending of a control signal, and an operation consisting in adjusting each actuator in the group of actuators by using each status signal of that actuator to update the control signal sent to that actuator, the term “update” here being synonymous with “bringing up to date by using the most recent known value”.

The invention likewise relates to an installation for employing a deposition method such as that defined in the foregoing, this installation being characterized in that it comprises actuators and an adjustment module, in that the actuators are designed to act on the thickness of the coating as a function of control signals or instructions that they receive, and to supply corrected status data to the adjustment module, and in that the adjustment module is designed to determine by predictive control the control signals or instructions to be sent to the actuators to cause the thickness of the coating as measured to move toward the target value for that thickness.

Preferably, an installation of this type comprises, as an actuator, one or more of the following elements: a blown-air drying machine with an adjustable lip, a split electromagnetic profile corrector, and devices such as jacks for positioning the anti-crossbow roll, the pass line roll, and/or the bottom deflecting roll.

Other characteristics and advantages of the invention will emerge clearly from the description of it given below, by way of indication and not limitation, with reference to the annexed drawings in which:

FIG. 1 is a large-scale partial transverse-section view of a substrate protected by a coating deposited by the traditional route;

FIG. 2 is a schematic side view of part of a galvanizing installation;

FIG. 3 is a schematic detail view illustrating the action of a blown-air drying machine;

FIG. 4, made up of FIGS. 4 to 4c, is a schematic transverse-section view of a coating installation, representing various arrangement defects of the substrate strip with respect to the drying machines, and the associated defects in the finished product;

FIG. 5 is another schematic side view of part of a galvanizing installation;

FIG. 6 is a perspective detail view of a portion of strip passing in front of two drying machines;

FIG. 7 is a schematic perspective view of an air-jet drying machine;

FIG. 8 is again another schematic side view of part of a galvanizing installation;

FIG. 9 is a schematic perspective view of part of a continuous galvanizing installation;

FIG. 10 is another schematic side view of part of a galvanizing installation;

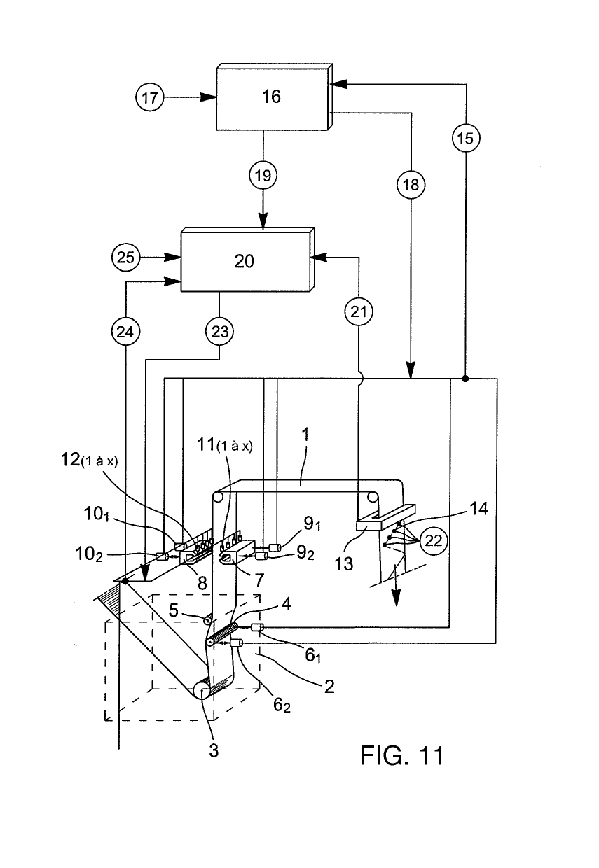

FIG. 11 is a diagram illustrating an installation in accordance with the invention; and

FIG. 12, made up of FIGS. 12a and 12b, is a schematic view illustrating the action of a blown-air drying machine (FIG. 12a) and the physical law describing this action (FIG. 12b).

As pointed out in the foregoing, the invention relates to (FIG. 11) a method for the continuous deposition of a coating, in particular of zinc, on a substrate such as a strip of steel of defined width, and in which the thickness of the coating on the surface of the substrate needs to move toward a target value that is in general constant for the whole surface of the substrate.

This method comprises a deposition operation during which the strip 1 forming the substrate is conveyed by continuous feeding and plunges into a bath of liquid zinc 2 where it is deflected by a bottom roll 3. This strip 1 then passes between an “anti-crossbow” roll 4 and a pass line roll 5, and exits from the bath of zinc coated with a layer of liquid zinc that is dried between two blast-air drying machines 7 and 8. A thickness gauge 13 measures the thickness of the dried and solidified coating, the combined movements of the strip 1 and the sensor of the gauge 13 forming a path 14. The roll 4 and the drying machines 7 and 8 are equipped with respective actuators such as 6₁, 6₂, 9₁, 9₂, 10₁, 10₂, 11₁ to 11ₓ, and 12₁ to 12ₓ.

These actuators are controlled by respective control signals that constitute setting instructions for the actuators, and are capable of transmitting back respective status signals representing the settings that they have actually carried out.

The inventive installation comprises a preparation or pre-setting module 16 in which a static pre-setting model, established by experimentation, has at least been stored in memory in advance of the deposition operation and including, for each of the points 22 distributed along the width of the substrate 1 and for each actuator, a quantitative relation linking the thickness of the coating at that point to the value of one or more components of the control signal capable of being supplied to that actuator.

Prior to or at the very start of the deposition operation, the actuators such as 6₁, 6₂, 9₁, 9₂, 10₁, 10₂, 11₁ to 11ₓ, and 12₁ to 12ₓ send status signals or data 15 to the preparation module 16 notifying this module 16 of their situation. On the other side, this same preparation module 16 receives, in the form of data 17, the operational variables that specifically define the target value for the thickness of coating to be deposited. The pre-setting model stored in memory in the preparation module 16 allows same to supply pre-setting instructions to the actuators 6₁, 6₂, 9₁, 9₂, 10₁, 10₂, 11₁ to 11ₓ, and 12₁ to 12ₓ.

The inventive method likewise employs an adjustment model including, for each of the points 22 distributed along the width of the substrate 1 and for each actuator, a quantitative relation linking a variation in the thickness of the coating at that point to a variation in the value of at least one component of the control signal supplied to that actuator.

This adjustment model can be stored in memory in an adjustment module 20, or stored in memory in the preparation module 16 and transmitted by same to the adjustment module 20.

On the basis of this adjustment model and the thickness measurement data 21 obtained for the various points 22 on the width of the strip 1, the adjustment module 20 determines by predictive control the control signals or instructions 23 that this module 20 needs to send to the actuators 6₁, 6₂, 9₁, 9₂, 10₁, 10₂, 11₁ to 11ₓ, and 12₁ to 12ₓ, from which it receives the corrected status data 24 in order to cause the thickness of the coating as measured to move toward the target value for that thickness in order to cause the thickness of the coating as measured to move toward the target value for that thickness.

In other words, the inventive method uses a model for predicting the transverse thickness of coating, allowing the development of the controlled variables to be predicted, the construction of this model allowing it to be linear.

In accordance with the general principle of predictive control, this model uses the measurement of the coating thickness over the width of the strip 1 in the form of a vector of dimension “n” corresponding to the number of measuring points 22 considered. A vector of dimension “n” corresponds to each dynamic actuator interrogated (for example each of the “m” actuators for setting the thickness of the air jet) and the effect of the set of actuators is expressed in the form of a rectangular matrix of “n” lines corresponding respectively to the measuring points 22 considered and “m” columns corresponding respectively to the dynamic actuators interrogated.

The optimization of the control signals to be applied to the dynamic actuators is preferably carried out by using a quadratic cost function typically representing the Euclidian distance between the thickness measured at the various measuring points 22 and the target value for the thickness.

This optimization is carried out by effecting the minimization of this cost function while taking account of various constraints on the various influencing variables formed by the statuses of the various actuators, these constraints being capable of being fixed in the model or being introduced in the form of data 25.

These constraints include specifically:
the minimum functioning distance d of the device for setting the thickness e of the air jet (FIG. 12). In fact, if the variation in the thickness e is to be translated into a variation in pressure P on the coating, the strip 1 must be fed in the zone of the jet where P=f(d) with d≧do (FIG. 12b); and
the minimum camber that the strip 1 needs to display to preserve a certain longitudinal rigidity, limiting the vibration problems.

The inventive method can also take account of other measuring data, such as the thickness measurement of the “hot” gauge JC for coating thickness, and strip profile measurements supplied by the sensor MPB.

The inventive method can likewise control actuators other than those referred to in the foregoing, and specifically the actuators ACT_RAT of the “anti-crossbow” roll RAT (FIG. 9) and those of the magnetic profile corrector CMP.

The inventive method likewise allows supplementary devices to be included in the system of adjustment, such as magnetic or blown-air pre-drying machines, or additional devices for controlling coating thickness, which are specific to the edges of the strip 1.

In general, the inventive method offers great ease of integration for new actuators or measuring instruments in the course of the development of the installation.

1-11. (canceled)

12. A method for the continuous deposition of a coating on a strip-type substrate of defined width, with convergence toward at least one target value of a thickness of the coating on the substrate surface, the method which comprises:
performing a deposition operation and thereby conveying the substrate along a longitudinal feed direction perpendicular to a width of the substrate in an installation having a set of actuators controlled by respective control signals each including at least one component, and wherein each actuator of the set of actuators is configured to influence the thickness of the coating along the width of the substrate in dependence on the control signal received thereby;
in a first preliminary modeling phase, employed upstream of the deposition operation, developing a pre-setting model including, for each point in a set of points distributed along the width of the substrate and for each actuator, a quantitative relation linking the thickness of the coating at the respective point to a value of at least one component of the control signal supplied to the respective actuator;
in a second preliminary modeling phase, employed upstream of the deposition operation, developing an adjustment model including, for each point in the set of points and for each actuator, a quantitative relation linking a variation in the thickness of the coating at the respective point to a variation in the value of at least one component of the control signal supplied to the respective actuator;
in an intermediate pre-setting step, employed upstream or at a start of the deposition operation, transmitting control signals to the actuators depending on the pre-setting model and the target value for the thickness of the coating at each point in the set of points;
in a measuring step, employed during the deposition operation, measuring the thickness of the coating at each point in the set of points; and
in an adjustment step, employed during the deposition operation and following the pre-setting step, transmitting respective control signals to the actuators, wherein the control signals have been processed by predictive control on the basis of the adjustment model and a cost function taking into account any potential difference between the target value and the thickness measurement at each point in the set of points.

13. The deposition method according to claim 12, wherein the substrate is a strip of steel, the coating is zinc or a zinc alloy, and the method constitutes a galvanizing process.

14. The deposition method according to claim 12, wherein the adjustment model is a linear model.

15. The deposition method according to claim 12, wherein the cost function is a quadratic function.

16. The deposition method according to claim 12, which further comprises:
producing, at least at the level of each actuator in a group of actuators, at least one status signal representative of a status of the respective actuator;
acting on at least one actuator in the group through means complementing the sending of a control signal; and
adjusting each actuator in the group of actuators by using each status signal of that actuator to update the control signal sent to the respective actuator.

17. An installation for employing the deposition method according to claim 12 for depositing a coating of zinc or a zinc alloy on a steel strip, the installation comprising:
a plurality of actuators and an adjustment module connected to said actuators;
wherein said actuators are configured to act on a thickness of the coating being deposited in dependence on control signals or instructions received thereby, and to supply corrected status data to said adjustment module; and
wherein said adjustment module is configured to determine, by predictive control, the control signals or instructions to be sent to said actuators to cause the thickness of the coating as measured to move toward the target value for the thickness.

18. The installation according to claim 17, wherein said plurality of actuators includes a blast-air drying machine with an adjustable lip.

19. The installation according to claim 17, wherein said plurality of actuators includes a split electromagnetic profile corrector.

20. The installation according to claim 17, which further comprises an anti-crossbow roll, and said plurality of actuators include devices for positioning said anti-crossbow roll.

21. The installation according to claim 17, which further comprises a pass line roll, and said plurality of actuators includes devices for positioning said pass line roll.

22. The installation according to claim 17, which further comprises a bottom deflecting roll, and said plurality of actuators includes devices for positioning said bottom deflecting roll.
